(19) United States
(12) Patent Application Publication
(10) Pub. No.: US 2006/0112020 A1
(43) Pub. Date: May 25, 2006

(54) Generation and management of a rights context for order handling in technical processes

(76) Inventors: Karlheinz Dorn, Kalchreuth (DE); Ralf Hofmann, Puschendorf (DE); Ivan Murphy, Baiersdorf (DE); Andreas Schuelke, Herzogenaurach (DE)

Correspondence Address: HARNESS, DICKEY & PIERCE, P.L.C., P.O.BOX 8910, RESTON, VA, 20195, US

(21) Appl. No.: 11/281,470

(22) Filed: Nov. 18, 2005

Related U.S. Application Data
(60) Provisional application No. 60/628,952, filed on Nov. 19, 2004.

(30) Foreign Application Priority Data
Nov. 19, 2004 (DE) 10 2004 055 938.4

(51) Int. Cl. G06Q 99/00

(52) U.S. Cl. 705/59

(57) ABSTRACT

An apparatus, a method and a system arrangement are disclosed for executing an order from a user, in which it is necessary to check authorization to execute the order from the user. The authorization to execute the order is defined in a rights context. When the order is given by a user, the rights context for the order is recorded, checked and frozen for the duration of the order so that it is possible to ensure that the order can be executed fully even when the rights context is changed at the time of execution.

The present application hereby claims priority under 35 U.S.C. §119 on German patent application number DE 10 2004 055 938.4 filed Nov. 19, 2004, and hereby claims priority under 35 U.S.C. §119 on U.S. provisional patent application No. 60/628,952 filed Nov. 19, 2004, the entire contents of each of which is hereby incorporated herein by reference.

### FIELD

The invention generally relates to the field of order handling in technical processes, at least some of which require authentication or authorization to execute the order.

The invention relates particularly to the execution of such orders and the management of rights which are relevant in connection with the execution of the order.

The primary area of application of the present invention is any technical processes which can be broken down into a multiplicity of functions, orders or sub-processes in a distributed system and which require order authorization. A large number of technical processes require authorization or authentication to execute the process. This is the case particularly for processes which are based on processing security-related data. Examples of these are medical systems, which process security-critical patient data. Another area of application is systems for payment transactions, which process security-related data in the form of credit card numbers, PIN numbers or other account-specific data.

### BACKGROUND

Systems used are normally multiuser systems in which an order can be executed and/or initiated by different users. It is therefore necessary to ask for or record the respective user's authorization before such an order is executed. Thus, by way of example, a doctor from an X-ray department will normally have more extensive access rights to X-ray pictures than a medico-technical assistant in a laboratory, who requests X-ray pictures only in exceptional cases.

Since the users in multiuser systems will inevitably fluctuate, it is necessary to manage the rights of the various users. On the one hand, it is necessary to allow for the possibility of new users being added and existing users being removed. On the other hand, existing rights for one and the same user may also be altered over time. These alterations need to be taken into account. Depending on the area of application, it is possible for the order to take a relatively long interval of time, which means that several rights checks are required while the order is being executed. Similarly, it is possible for the order to be a follow-up order, e.g. the order to label all freshly-produced X-ray pictures. Overall, the total order may be an order of unlimited duration.

Difficulties arise in systems from the prior art when the two aforementioned context conditions relating to the situation are met, namely when a complex or long order requires multiple checking of a rights context and when it is additionally possible for this rights context to change during the period in which the order is executed. The cumulative occurrence of these two scenarios would frequently result in serious errors in the case of known systems.

If, by way of example, a doctor as a user of the system needs to access particular X-ray picture records, and the access rights change on account of general configuration changes for this user during access (initially the doctor has all rights and then has his rights restricted), it has normally not been possible to date for the order to be able to be executed fully. This might have entailed further errors, for example by virtue of the pictures not being available on an X-ray film for diagnosis at the correct time, pictures being lost, the pictures needing to be ordered again and/or configuration changes needing to be reversed centrally so as then to have the order executed again.

It has not been known practice to date to perform processing using medico-technical appliances which allow for dynamic alteration of access rights and/or a security context.

To date, provision has been made for configuration changes to be made only if no activities are taking place on the respective medico-technical appliances for which the respective configurations should apply. The possibility of making a configuration change even during operation or during access has therefore been very limited to date.

In addition, the procedure in the case of the known systems resulted in the drawback that it was possible to block the alteration of the rights context by virtue of a user initiating orders recurrently or initiating very long orders, since it was not possible before now to change the rights context during the time in which the order is executed.

### SUMMARY

At least one embodiment of the present invention therefore includes an object of demonstrating a way of making allowances for a dynamic change to a rights context from a user during the execution of orders which may be given by a plurality of users and which allows a security environment for the user to be managed.

An object may be achieved by a method for executing an order, where the order requires at least one order authorization and can be executed fully and soundly only if a check on the order authorization takes place successfully, the order authorization being defined in a “rights context”, having the following method steps:
the order authorization is checked before the order starts to be executed by processing the recorded rights context and, if the check is successful:
the order is executed using the recorded rights context.

Normally, in at least one embodiment, the method is initiated as soon as a rights check is required for an order. However, it is also possible for the method to be applied iteratively by also performing it a plurality of times for an order. This makes sense when the order is split into a plurality of suborders and which occur when a plurality of rights checks are necessary over the duration of the order execution.

Normally, in at least one embodiment, provision is made for the rights context for the inventive method to be defined and recorded for a user and/or for a group of users. Alternatively or cumulatively, it is also possible for the rights context to be defined and recorded for one particular order.

Besides the access rights of the respective user, the rights context also includes the security environment for the user and may additionally include further settings and parameters, such as particularly the access rights to data objects, rights for newly created data, user-specific settings and/or filters which are intended to be applied for auditing (security-related checking mechanisms and methods) etc.

In at least one example embodiment, the recording, the checking and/or the execution of the order take place automatically. This has the advantage that incorrect inputs can be avoided and the respectively required data records can be read in automatically via interfaces which are provided. Alternatively, however, it is possible for at least one of these three aforementioned operations also to be executed semi-automatically by virtue of the necessary data being able to be input via a user interface or being read in from associated files.

In at least one example embodiment, the system may be in a form such that dynamic alteration of the order authorization and/or of the rights context is possible. This makes it possible to alter the order authorization and/or the rights context even while an order is being executed without influencing the execution of the order. The order is in that case executed using the rights context which was current immediately prior to the start of execution of the order.

As such, the inventively recorded rights context remains constant during execution of the order. This ensures that only the user's respective current security environment is used for order execution. This increases the reliability of the system, since it is ensured that an order is executed fully—even when there is a change to the rights context. In addition, the flexibility of the system is increased by virtue of the rights context being able to be altered at any time without impeding or disturbing the order execution for an ongoing order.

Advantageously, at least one embodiment of the method involves managing the rights context. The rights context may be, for example, managed automatically. Management of the rights context involves recording the rights context for the first time, recording changes to the rights context, updating the rights context in relation to the respective ongoing order and deleting the rights context if it is no longer required, e.g. when the order has been executed fully.

It is possible for an order to have suborders. This is the case when a relatively involved and complex technical process is broken down into technical subprocesses, some of which can also be executed beyond computer boundaries on other applications. In the case of the solution based on at least one example embodiment of the invention, these technical subprocesses may also be taken into account in the management task.

It is thus possible, for example, to have a preset stipulating that a subprocess automatically inherits the rights context from the process which is higher in the hierarchy. In addition, it is possible for a plurality of orders to be executed in parallel—at the same time or at different times—on a plurality of applications with a respective different rights context for a user.

A preset stipulates that the rights context which is respectively applicable immediately prior to the start of execution of the order is automatically applied for the respective order. In one alternative example embodiment of the invention, the rights context is not constant for the entire duration of the order, but rather can be altered for smaller subunits of the order and is thus respectively redetermined a plurality of times for an order.

An order is basically a technical process which requires technical appliances, particularly medico-technical appliances, to be processed. The order is therefore appliance-based and preferably makes use of hardware and/or software modules. Normally, an order is distributed over a plurality of applications which are respectively connected to one another for the purposes of communication via a network. It is possible for there to be a different rights context for one and the same user for different applications and/or for different orders at any time.

The method includes a plurality of method steps which do not necessarily have to be executed on one and the same appliance. Thus, it is possible for the definition of the rights context, the recording of the rights context, the checking of the order authorization and/or the execution of the order itself to be respectively performed on different appliances and hence also ‘remotely’. In this case, all the appliances are usually connected for the purpose of data communication via a network. Normally, the rights context is allocated and defined centrally and at a different location (in relation to the data network) than the check on the user's access authorization to data records in a particular application.

Normally, the rights context is associated with a user. Besides the user's authorizations to access applications, data records in the applications and functions within the applications (burning a CD, sending data via a network, executing particular application-specific functionalities), the rights context also includes the user name and its domain, the user's group association and/or particular presets for the user.

Alternatively, provision is made for the rights context to be in order-specific form, so that an order has a definition of which user or which group of users is authorized to execute this order. In one advantageous development of at least one embodiment of the invention, the rights context is in both user- and order-specific form. This advantageously allows the flexibility of the system to be increased by virtue of it being possible to set further details relating to security, allocation of rights, presets etc.

One particular advantage of at least one example embodiment of the inventive method can be seen in that the allocation or definition of the rights context is detached in terms of time and/or content from the check on the rights context. This makes it possible for the rights context to be defined centrally and at any time, whereas the rights context is checked only when it is required.

In at least one example embodiment, the check is performed immediately prior to execution of an order and/or prior to an action requiring authorization during execution of the order (e.g. access to security-related data), in order to ensure that the respective current security context and rights context are taken into account for the respective order or for the necessary actions of the order. Normally, the rights context is recorded and the order authorization is checked in a time interval whose timing precedes execution of the order. The recording of the rights context is independent of this.

If the order is a complex order which is divided into suborders, one advantageous development of at least one embodiment of the invention has a preset that the rights context for the order which is higher in the hierarchy is automatically used in identical fashion as a rights context for the suborders which are lower in the hierarchy. The suborders then use the recorded or frozen rights context for the order. In this example embodiment, a status for the rights context is handed down to suborders. In this case, the method step of checking the order authorization for the suborders can be dispensed with. The order authorization is checked only for the order itself, and all suborders are automatically recorded as authorized and hence automatically executed. If it is found to be appropriate also to perform order authorization for the suborders, however, then in one alternative embodiment the order authorization for executing the suborder is checked automatically or optionally according to the system administrator's setting.

In principle, at least one embodiment of the inventive solution is in a form such that during order execution only the recorded rights context applies. In parallel with this, however, there may be a rights context for the user which allows for configuration changes which arise at the time of execution of the order or at the order handling time, for example. This (general) rights context then applies to future executions of orders, but not to the order handling which is in progress. In addition, provision is made for the recorded rights context to exist and be stored in the system only for the duration of the order execution and to be deleted again after order execution has ended. This results in simpler maintenance and updating of the system.

In a further advantageous development of at least one embodiment, the inventive method covers an additional method step:
the recorded rights context is indicated.

This makes the order handling more transparent for the respective user. This is because if the check on the order authorization reveals that the user is not authorized for this order, the order cannot be executed. An appropriate window then appears on a screen interface and draws the user's attention to this fact. However, so that the user is not confronted with unnecessary indications of successful checks on the access authorizations, one alternative example embodiment of the invention has provision for the indication to be given only if the check was not successful.

In at least one example embodiment, the management of the rights context is not local to the process and can thus also be used by other processes and/or other applications or computers.

At least one embodiment of the invention is based on the use of a central rights context. This advantageously also allows central management or alteration of the rights context. Previous systems are based on application-managed monitoring of access rights. Central management has not been possible to date.

An object may be achieved by an apparatus and/or a system arrangement. The embodiment options and alternative forms of the inventive method which have been described above may likewise be applied to the inventive apparatus and to the inventive system arrangement.

The inventive embodiments of the method which are described above may also be in the form of a computer program product and/or computer readable medium, the medium being readable by a computer and with a computer program and associated program code, the computer being prompted to carry out the inventive method described above after the computer program has been loaded.

One alternative way of achieving an object is provided by a storage medium which is intended to store the computer-implemented method described above and which can be read by a computer.

### BRIEF DESCRIPTION OF THE DRAWINGS

The detailed description of the figures below discusses example embodiments, which are not to be understood as restrictive, with their features and further advantages with reference to the drawing, in which:

FIG. 1 shows an outline illustration of fundamental modules based on an example embodiment of the invention,

FIG. 2 shows a flowchart based on an example embodiment of the invention, and

FIG. 3 shows a flowchart of an embodiment of order execution based on the invention.

### DETAILED DESCRIPTION OF THE EXAMPLE EMBODIMENTS

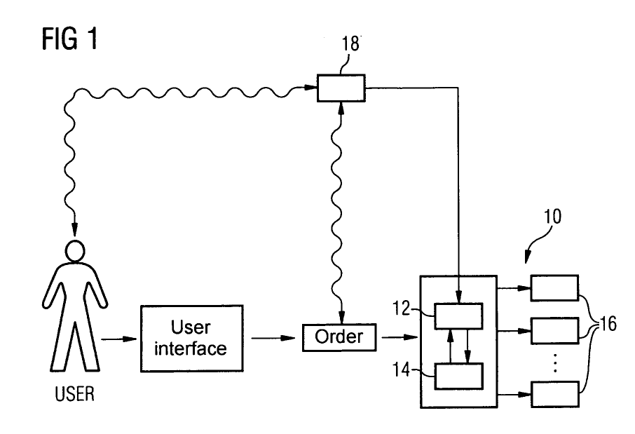

In connection with FIG. 1, the text below gives an explanation of the fundamental modules and components in line with an example embodiment of the invention.

An apparatus, denoted generally by 10, includes at least one recording module 12, at least one checking module 14 and usually a plurality of execution modules 16.

Normally, the system is in the form of a multiuser system. Thus, a multiplicity of users can execute orders or initiate processes. If the inventive solution of at least one example embodiment is applied to medico-technical systems in a complex organization, such as in a hospital, then the different users each need to be uniquely allocated particular rights in a security environment and/or user-specific parameters and settings. These settings are combined in a “rights context” 18.

The rights context 18 is preferably a user-specific data structure. This is indicated in FIG. 1 by the curved line, which is intended to illustrate an association between the user and the rights context 18. However, it is also possible to produce the rights context 18 on an order-specific basis. This is indicated by the curved line in FIG. 1 between the order and the rights context 18.

Each order is then assigned an order-specific rights context 18. If a doctor wishes to access a particular X-ray film for diagnosis, for example, his rights context 18 needs to be in a different form than when, by way of example, an assistant merely wishes to check the recorded X-ray pictures for completeness without manipulating the data further. In the first case, the doctor should have more extensive access rights which also allow irrelevant pictures to be deleted, for example.

Normally, an order is split over a plurality of execution modules 16 which for their part interchange data with one another and with further modules via a network. Normally, a complex order accesses various applications or processes or execution modules 16. This situation is shown in FIG. 1.

If, by way of example, a user of a hospital information system gives this system an order to read in a sheet of X-ray film, it will normally be necessary to instruct an execution module 16 situated at a remote location. In line with at least one example embodiment of the invention, before the order it is now necessary to check whether the respective user is also authorized to execute the order.

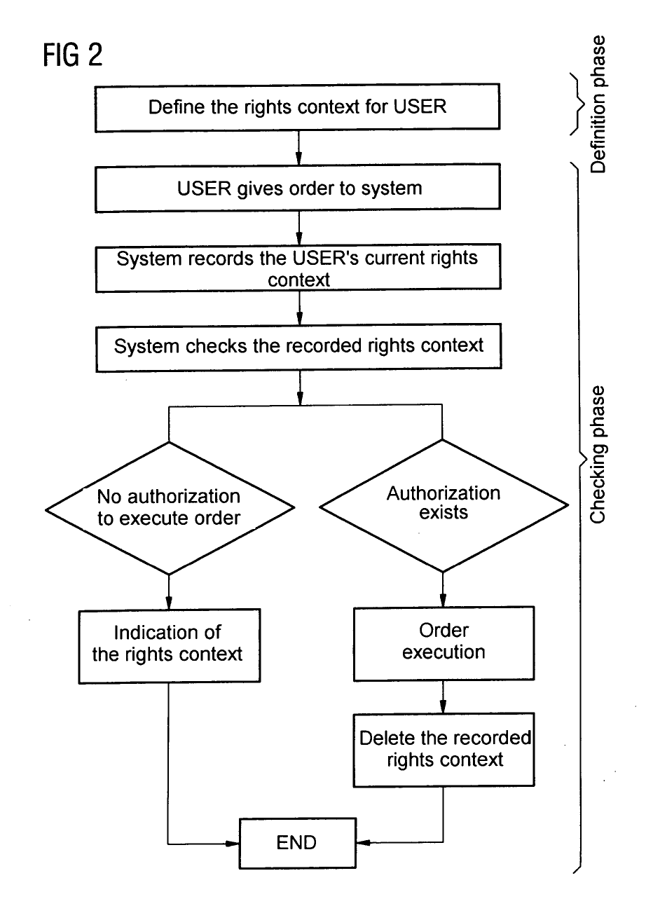

Each user of the system is therefore allocated a rights context 18. It is possible for this rights context 18 to change. Thus, the user's access rights can also be extended or restricted during an order, in particular. The rights context 18 for a particular user can be defined or allocated at any time in a central definition phase. This phase is detached from the subsequent checking phase in terms of time and/or content. This is illustrated in FIG. 2.

Immediately prior to the order being executed, the user's rights context 18 is accessed. The user's rights context 18 recorded by use of the recording module 12 is then supplied to the checking module 14. The checking module 14 is used to check whether the user is also authorized to execute the order and, by way of example, can read and/or manipulate particular data records. If this checking operation is successful, the order can be executed. The respective applications 16 required for executing the order are then addressed automatically. The order can then be terminated successfully.

However, one aspect of at least one example embodiment of the present invention relates to the alteration of the rights context 18 during order execution. Thus, it was previously not possible to change the rights context 18 during processing, or changing the rights context 18 in the course of order handling inevitably resulted in what were in some cases serious errors, since the respective applications were confronted with an inconsistent data situation for the rights context.

If the user in the example cited above has the right to read and manipulate the data, and if he then starts to alter an order, i.e. data records from a sheet of X-ray film, the user normally receives confirmation from the system that his order can be executed successfully, since he is authorized to execute the order, of course. If this authorization now changes after the start of order execution, however, and if order execution requires a plurality of rights checks then the rights checks with later timing result in an error in previous systems, since the user is now no longer authorized to execute the order. The order cannot be executed fully even though the user was authorized before the start of the order. This incorrect response from the system based on the prior art is avoided with the solution based on at least one example embodiment of the invention.

This is achieved by reading in and recording the rights context 18 of the respective user immediately prior to order execution. Over the duration of the order, this recorded rights context 18 can no longer be altered for the respective order. If the user is thus authorized to execute the order when the order is given, this order is also executed fully and correctly, regardless of whether the rights context changes during execution of the order.

If this is the case and if the user has access rights withdrawn from him during order execution, for example, this is stored in a management module for the rights context 18. For the current order execution, however, the rights context 18 recorded by the recording module 12 continues to be valid. The state of the rights context 18 immediately prior to order execution is thus frozen for the duration of order execution. When the order has been terminated successfully, the recorded rights context 18 can also be deleted again. For future orders from the user, the possibly altered rights context can then be used.

FIG. 2 shows a flowchart based on at least one example embodiment of the present invention.

At least one example embodiment of the inventive method is broken down into a definition phase and a checking phase, which can take place in isolation from one another in terms of time and/or content. In the definition phase, the rights context 18 is defined or allocated for a user or for a user group, preferably at a central location. Normally, the rights context 18 is defined when the user logs in. However, it is also possible for this definition to be made at stipulated and preset times.

When the user now gives an order to the system, for example to access data records from a computer tomograph, he thereby starts the checking phase. The checking phase is decoupled from the definition phase. Following the instruction, the system records the rights context 18 for the respective user. There then follows a check on the rights context 18. This particularly examines whether the user is also authorized to access the desired data records. If the result of the check is that he is not authorized then at least one example embodiment of has provision for the respective rights context 18 to be indicated on a screen interface. This provides the user with an indication of the fact that he is not authorized to execute the order. The method then ends.

However, if the result of the check is that the user is authorized to execute the order, the order is automatically executed by accessing the respective execution modules 16. When the order has been terminated fully, the user's rights context 18 recorded for the respective order can be deleted. For further, future orders, a current rights context is in turn recorded again. The method can be applied iteratively.

In at least one example embodiment, the rights context 18 includes not only the access rights but also privileges for the respective user and further user-specific settings or data which reference the identity of the user. In addition, it is in this case also possible to make settings to the effect that objects which are generated by the user—for example particular image data records from a radiologist—can be accessed only by a particular group of users.

A user is thus able to determine who is authorized to access the objects which he generates. This authorization can be provided for each data record individually or for a class of data records (e.g. for all data records relating to one patient). In addition, the rights context 18 includes user-specific settings and/or order-specific parameters and/or settings, e.g. for filters which are to be applied during auditing. In the rights context 18, for example, it is possible to set how and in what form particular user groups are intended to receive particular objects or data records. The rights context 18 is thus central.

For this reason, at least one example embodiment of the invention has provision for a management module to be additionally provided which is intended to manage the rights context 18. The management module preferably operates centrally. This significantly simplifies the management of the rights context 18. In addition, it is possible to ensure that inconsistencies in the rights context 18 are avoided.

In at least one example embodiment, the inventive system does not actually access the rights context 18 when the user gives an order or when the user starts an activity, but rather only at the time within the application cycle which requires an authorization check. Thus, the inventive check on the rights context is tailored quite specifically to the time in the application cycle and can thus be used in the most up-to-date manner possible. In cases in which the rights context 18 does not change until immediately prior to the time of the check, this can be covered by at least one example embodiment of the invention. In this case, the current rights context 18 can thus be used to execute the order. This allows the security of the system to be increased.

At least one example embodiment of the inventive solution makes it possible to alter a rights context 18 even during the current order cycle without disturbing the order handling. In this case, the recorded rights context 18 which applies to the respective order differs from the rights context 18 which is altered during the order and which is stored in the management module and can be used only for later orders.

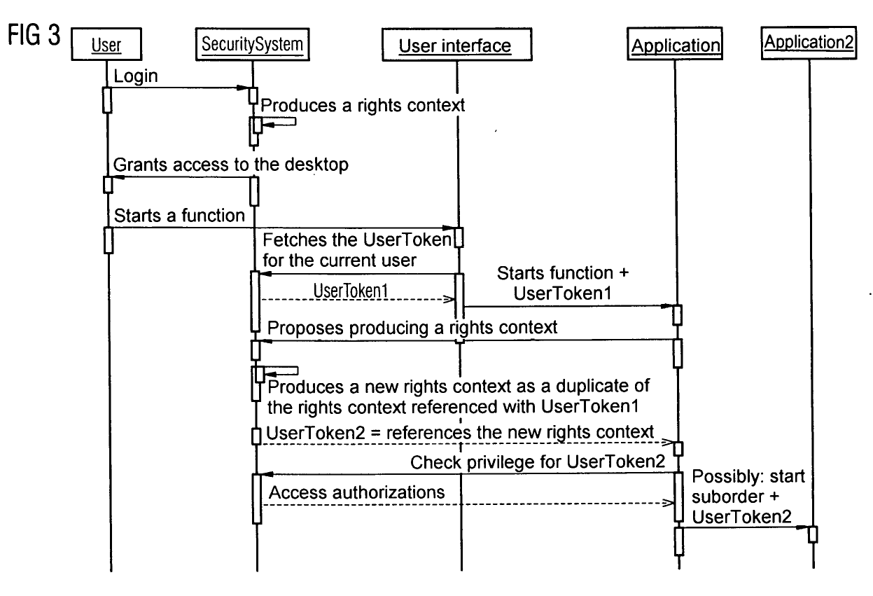

FIG. 3 shows a flowchart which shows order processing based on at least one example embodiment of the invention with a check on the rights context 18 for a background function. In this case, it again becomes clear that an order may also comprise suborders, which is indicated by the ‘Application2’ being called by the ‘Application’ in FIG. 3.

In at least one example embodiment of the invention, the rights context 18 is produced immediately during or after the user has logged into his system. This (general) rights context 18 can be altered later. When the user has logged in, the login computer can start orders directly and activate functions for which the rights context 18 is already taken into account. The rights context 18 remains on the computer which has logged in the user.

If further checks on the rights context 18 are now required at a later time, possibly on other computers (‘Application’ and ‘Application2’ in FIG. 3), these checks are not performed there, but rather the respective checks are delegated back to the login computer. This is possible because when an order is given to ‘remote’ computers only a reference to the rights context 18 and/or to the user is forwarded to the ‘remote’ computer, and the user identity (i.e. the user account) does not need to be forwarded or available there.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for executing an order which requires order authorization and is only executable upon a check on the order authorization being successful, the order authorization being defined in a rights context recorded for at least one of a respective user and a respective order, the method comprising:
checking the order authorization before the order starts to be executed by processing the recorded rights context; and
executing the order using the recorded rights context upon the check being successfully concluded.

2. The method as claimed in claim 1, wherein at least one of the recording, the checking and the execution are performed automatically.

3. The method as claimed in claim 1, wherein at least one of the order authorization and the rights context are dynamically variable, and wherein the recorded rights context remains constant while the order is being executed.

4. The method as claimed in claim 1, wherein the method involves managing the rights context.

5. The method as claimed in claim 1, wherein the order is appliance-based.

6. The method as claimed in claim 1, wherein at least two of the method, the definition of the rights context, the recording of the rights context, the checking of the order authorization and the execution of the order each take place on different appliances.

7. The method as claimed in claim 1, wherein the rights context is at least one of user-specific and order-specific.

8. The method as claimed in claim 1, wherein at least one of the recording of the rights context and the checking of the order authorization takes place before the order starts to be executed.

9. The method as claimed in claim 1, wherein an order includes at least one suborder, and wherein the suborder inherits the recorded rights context of the order.

10. The method as claimed in claim 1, wherein the recorded rights context exists only for the time during which the order is being executed and is then deleted.

11. The method as claimed in claim 1, wherein various orders from a user are executed in parallel using a respectively different recorded rights context.

12. An apparatus for executing an order, where the order requires order authorization and is only executable when the order authorization exists, the order authorization being defined in a rights context recorded for at least one of a respective user and a respective order using a recording module, the apparatus comprising:
at least one checking module to check the order authorization before the order starts to be executed by processing the recorded rights context; and
at least one execution module to execute the order using the recorded rights context if the checking module has sent a signal to the execution module which indicates that the check has been concluded successfully.

13. The apparatus as claimed in claim 12, wherein at least one of the recording module, the checking module and the execution module operate automatically.

14. The apparatus as claimed in claim 12, wherein at least one of the order authorization and the rights context are dynamically variable, and wherein the recorded rights context remains constant while the order is being executed.

15. The apparatus as claimed in claim 12, further comprising a management module for managing the rights context.

16. The apparatus as claimed in claim 12, wherein the order is appliance-based.

17. The apparatus as claimed in claim 1, wherein at least two of the apparatus, a module intended to define the rights context, the recording module, the checking module and the execution module are each associated with different appliances.

18. The apparatus as claimed in claim 12, wherein the rights context is at least one of user-specific and order-specific.

19. The apparatus as claimed in claim 12, wherein the recording module initiates recording of at least one of the rights context and checking of the order authorization before the order starts to be executed.

20. The apparatus as claimed in claim 12, wherein an order includes at least one suborder, and wherein the suborder inherits the recorded rights context from the order.

21. The apparatus as claimed in claim 12, wherein the recorded rights context exists only for the time for which the order is executed and is then deleted.

22. The apparatus as claimed in claim 12, wherein various orders from a user are executable in parallel using a respectively different recorded rights context.

23. A system arrangement for executing an order requiring order authorization and is only executable when the order authorization exists, the order authorization being defined in a rights context which is recorded for at least one of a respective user and a respective order using a recording module, the system arrangement comprising:
at least one management module to manage the rights context, particularly to manage changes to the rights context, at least one checking module to check the order authorization before the order starts to be executed by processing the recorded rights context; and
at least one execution module to execute the order using the recorded rights context if the checking module has sent a signal to the execution module which indicates that the check has concluded successfully.

24. The method as claimed in claim 2, wherein at least one of the order authorization and the rights context are dynamically variable, and wherein the recorded rights context remains constant while the order is being executed.

25. The method as claimed in claim 1, wherein the order is computer-based.

26. The apparatus as claimed in claim 12, wherein the order is computer-based.

27. The system arrangement of claim 23, wherein the at least one management module to manage the rights context is further to manage changes to the rights context.

28. A computer program, adapted to, when executed on a computer, cause the computer to carry out the method as claimed in claim 1.

29. A computer readable medium including program segments for, when executed on a computer, causing the computer to implement the method of claim 1.
